(19) United States
(12) Patent Application Publication
(10) Pub. No.: US 2002/0031622 A1
(43) Pub. Date: Mar. 14, 2002

(54) Plastic substrate for information devices and method for making same

(76) Inventors: Scott C. Ippel, Spring Lake, MI (US); Catherine A. Getz, Holland, MI (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 09/946,228

(22) Filed: Sep. 5, 2001

Related U.S. Application Data
(60) Provisional application No. 60/231,096, filed on Sep. 8, 2000.
(60) Provisional application No. 60/244,557, filed on Oct. 31, 2000.

(51) Int. Cl. C09K 19/00

(52) U.S. Cl. 428/1.6; 428/1.1

(57) ABSTRACT

An interactive information device for use as a touch panel, touch screen, digitizer panel, or pen-input device, or as a substrate for an information display device such as a liquid crystal display, incorporates a transparent, rigid substrate formed from cyclic olefin copolymer which is lightweight, dimensionally stable, stiff, durable and abrasion, break and flex resistant. The interactive information device includes a first, transparent, electrically conductive layer supported by the rigid substrate, a flexible, transparent substrate at least partially aligned with the rigid substrate and having a second, transparent, electrically conductive layer on a surface thereof, the second conductive layer being spaced from the first conductive layer. A plurality of transparent insulating spacer members/dots are positioned on one or both of the conductive layers to allow the conductive layers to engage when the flexible substrate is pressed. A method for forming such an interactive information device is also disclosed.

### CROSS REFERENCED RELATED APPLICATIONS

This application claims priority from U.S. Provisional Patent Applications Ser. No. 60/231,096, filed Sep. 8, 2000 and Ser. No. 60/244,557, filed Oct. 31, 2000, the disclosures of which are hereby incorporated by reference herein.

### FIELD OF INVENTION

This invention relates to an improved conductively coated transparent substrate suitable to use in an interactive information device such as a touch screen or a digitizer panel, or as a substrate for use in an information display such as a liquid crystal display, a plasma display, a field emission display, an electroluminescent display, an electrochromic display, or a cathode ray tube display. More particularly, this invention relates to a transparent plastic substrate that is abrasion-resistant, that has a low outgassing property, is not subject to swelling or warp when used in extreme climates such as in cold climates, hot climates and/or humid climates, can be coated, for example with a transparent, electrically conductive coating, such as in a vacuum deposition process involving heat and/or plasma surface activation, has excellent optical properties, has high stiffness, has good impact strength, has a low specific gravity, has good thermal properties, is melt-processable. The substrate is suitable for use in an interactive information device such as a touch screen or a digitizer panel, or as a substrate for use in an information display such as a liquid crystal display, a plasma display, a field emission display, an electroluminescent display, an electrochromic display, or a cathode ray tube display. Most particularly, this invention preferably relates to a transparent conductively coated, transparent plastic substrate formed from a polymer resin comprising a cyclic olefin and, preferably, formed from a cyclic olefin copolymer. This invention also encompasses use of the cyclic olefin polymer material for forming a rigid transparent plastic panel or backplate for use for a touch screen product configuration with a backing plate, or as a substrate for an information display.

### BACKGROUND OF THE INVENTION

Interactive information devices such as touch panels and pen-input devices usually use at least one rigid glass substrate coated with a transparent conductive coating such as indium tin oxide (ITO) or doped tin oxide. While use of a plastic substrate such as a polycarbonate substrate or an acrylic substrate or a polystyrene substrate has been suggested, commercially successful interactive information devices in use today typically use an outer plastic, flexible substrate (typically ITO-coated plastic film such as ITO-coated Mylar®) that presses (by finger touch or by stylus pressure) to contact an underlying ITO or tin oxide transparent conductive coating on a rigid glass substrate. When an ITO-coated rigid plastic, polycarbonate, acrylic or polystyrene substrate is used, problems arise due to substrate heat distortion, difficulty in surface bonding/coating, inadequate stiffness and a variety of other factors that previously have rendered use of optical plastics in interactive information displays unsuccessful, and have limited the use of optical plastics in information displays such as liquid crystal displays.

### SUMMARY OF THE INVENTION

This present invention overcomes the problems limiting the use of optical plastics in interactive and other information displays by including an improved material and improved product comprising a cyclic olefin copolymer plastic substrate for use in an information device. More specifically, this invention uses a rigid plastic substrate formed from a polymer resin comprising a cyclic olefin, and preferably formed from a cyclic olefin copolymer (COC) such as available from Ticonca of Summit, N.J., USA under the trademark “Topas”. Cyclic olefin-containing resins are improved materials for a rigid, transparent, conductively coated substrate suitable for use in an information display. The improved display device incorporating the improved plastic substrate is lightweight, durable, flex-resistant, dimensionally stable, and break-resistant as compared to the conventional substrate for information devices.

In one form, the invention is an interactive information device comprising at least one rigid, transparent substrate formed from a cyclic olefin polymeric material, a first transparent electrically conductive layer supported by a surface of the rigid substrate, a flexible, transparent substrate at least partially aligned with the rigid substrate having a second transparent, electrically conductive layer on a surface thereof which faces the surface of the rigid substrate that supports the first electrically conductive layer, the flexible substrate being spaced from the rigid substrate to provide a gap between the conductive layers, and a plurality of insulating spacer members on at least one of the electrically conductive layers. The flexible substrate may be flexed by pressing to engage the electrically conductive layers between the spacer members.

In more specific forms of the interactive information device of the present invention, the first conductive layer is a conductive coating supported by depositing the coating on a surface of the rigid substrate. Alternately, another flexible, transparent substrate is aligned with the rigid substrate and includes the first, transparent, electrically conductive layer as a conductive coating thereon such that the surface of the another flexible transparent substrate that includes the first electrically conductive layer faces the second transparent conductive layer while the rigid substrate forms a transparent supporting backplate for the another flexible substrate. In either form, the flexible substrates may be formed from polymeric film and the conductive layers may be conductive coatings of tin oxide, indium tin oxide, or doped tin oxide.

In preferred forms of the invention, the cyclic olefin of the rigid substrate has a specific gravity below about 1.2, a coefficient of thermal expansion less than about 6.5 XE-5 per degree K, a percentage of water absorption by weight of less than about 0.2 percent, a heat distortion temperature of greater than about 120 degrees C., a flexural modules of at least about 300 Kpsi, an IZOD impact strength of at least about 0.4 foot-pounds per inch, a tensile strength of at least about 8 Kpsi, a visible light transmission measured photopically of at least about 90 percent, a clarity of at least about 98 percent, and a haze of less than about 1.5 percent. Further, the cyclic olefin of the preferred rigid substrate is melt-processable, chemically resistant, resistant to acid etching, and has low outgassing properties.

In other aspects, the invention also comprises a method for making an interactive information device comprising providing a rigid transparent substrate formed from a polymeric material comprising a cyclic olefin, providing a first transparent electrically conductive layer supported by surface of the rigid substrate, providing a first flexible transparent substrate having a second transparent, electrically conductive layer on a surface thereof; providing a plurality of insulating spacer members on at least one of the first and second electrically conductive layers, and securing the first flexible substrate to the rigid substrate such that the first and second conductive layers on the respective substrate are at least partially aligned with one another and spaced from one another by a gap in which the spacer members are positioned whereby the flexible substrate may be flexed by pressing to engage the conductive layers.

In preferred forms of the inventive method, the spacer members are formed by silk screening transparent polymeric material on one or both of the first and second electrically conductive layers followed by curing the formed spacer members.

The first electrically conductive layer may be supported on the substrate by coating a surface of the rigid substrate or by providing a second flexible, transparent substrate having the first electrically conductive layer thereon and securing the second flexible substrate to a surface of the rigid substrate. Portions of at least one of the first and second electrically conductive layers may be deleted to provide a touch screen pattern such as by conveyorized cleaning, ultra-sonic cleaning, plasma cleaning, ozone cleaning, photolithography, and laser deletion.

In yet another form of the invention, an improvement in an information display selected from the group consisting of a liquid crystal display, a plasma display, a field emission display, an electrochromic display, and a cathode ray tube display comprises a rigid substrate formed from cyclic olefin polymer resin, the substrate being light weight, dimensionally stable, durable and break and flex resistant. The substrate may include a transparent electrically conductive layer on a surface thereof and have the physical properties described above.

These and other objects, advantages, purposes and features of the invention will become more apparent from a study of the following description taken in conjunction with the drawings.

### BRIEF DESCRIPTION OF THE DRAWINGS

FIG. 1 is a sectional side elevation of a preferred embodiment of the resistive touch screen forming an interactive information device of the present invention;

FIG. 1A is a sectional side elevation of a second embodiment of the resistive touch screen forming an interactive information device of the present invention;

FIG. 1B is a sectional side elevation of a third embodiment of the resistive touch screen forming an interactive information device of the present invention;

FIG. 2 is a schematic flow diagram of the preferred method for forming a touch input device of the present invention;

FIG. 3 is a sectional side elevation of another embodiment of an interactive touch device of the present invention;

FIG. 3A is a sectional side elevation of yet another embodiment of an interactive touch device of the present invention;

FIG. 3B is a sectional side elevation of a further embodiment of an interactive touch device of the present invention.

### DESCRIPTION OF THE PREFERRED EMBODIMENTS

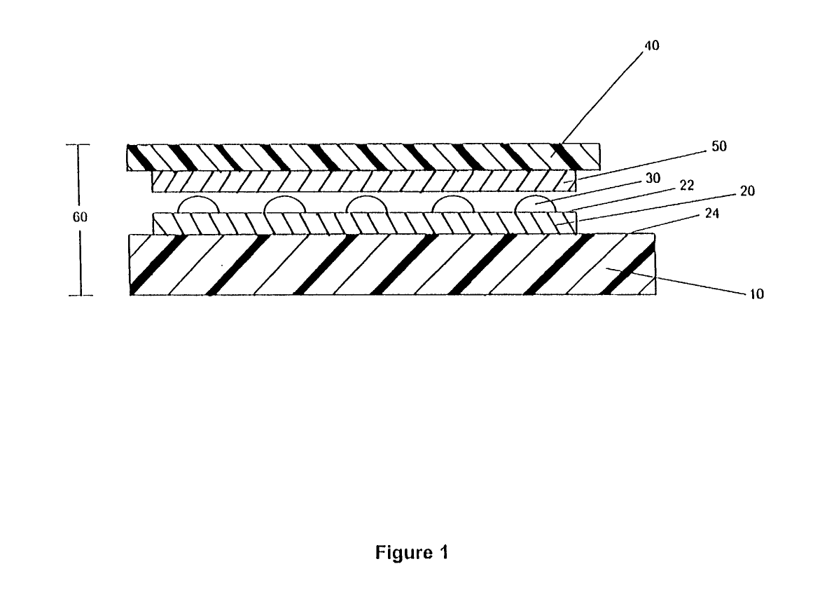

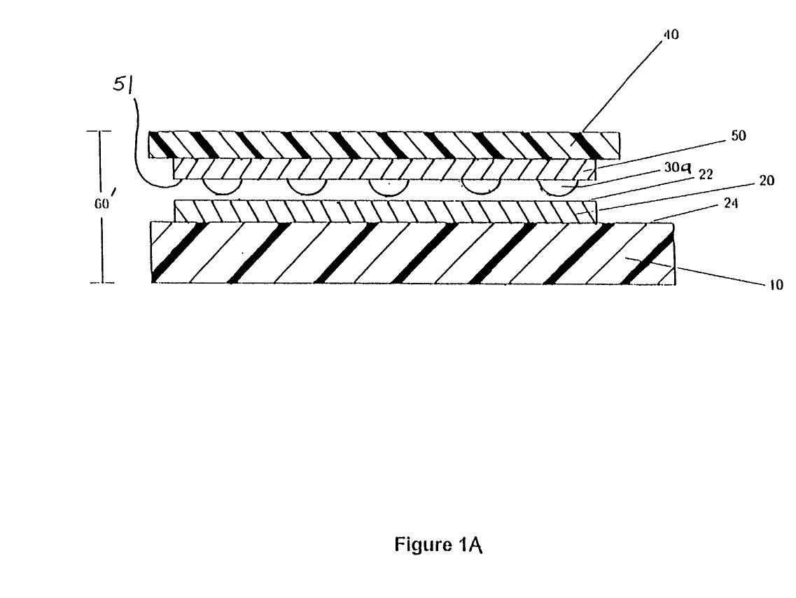

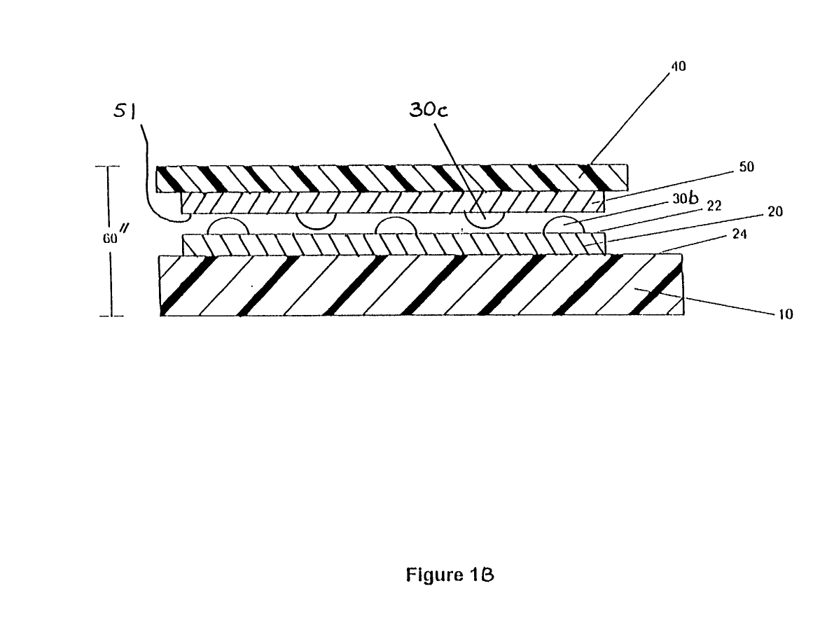

An interactive information device of the present invention is shown in FIG. 1. In this device, a resistive touch screen 60 uses a transparent rigid plastic substrate 10 with a transparent conductive film, coating or layer 20 (typically indium tin oxide of sheet resistance in the range of about 80 to about 1200 ohms/square; more preferably in the range of about 150 to about 900 ohms/square; most preferably in the range of about 400 to about 600 ohms/square) preferably deposited into surface 24 of substrate 10. Plastic substrate 10 preferably comprises an amorphous, glass-clear, cyclic olefin copolymer (COC). Suitable cyclic olefin copolymers are formed from straight chain olefins (such as polyethlylene) and cyclic olefins that are aliphatic (saturated) ring-structured materials. In a COC material, the cyclic olefin content imparts stiffness and increases glass-transition temperature. As the ratio of the cyclic olefin content to the non-cyclic olefin content increases in the comonomers used to form the COC resin, the heat distortion temperature (HDT) of the resultant COC plastic substrate formed from the COC resin correspondingly increases, with HDT's in the 160 to 350 degrees F. (at 66 psi) possible, dependent on the cyclic olefin content in the resin. A preferred COC resin is available from Ticonca of Summit, N.J., under the tradename “Topas”. Suitable materials to use for plastic substrate 10 include Topas 5013 and Topas 6013. Alternately, a cyclic olefin polymer material available from Nippon-Zeon of Tokyo, Japan, and available under the tradename “Zeonex”, can be used.

As shown in FIG. 1, transparent insulating spacer members or dots 30 (as known in the interactive information display art) are preferably arranged on surface 22 of transparent conductive coating 20 in order to provide separation between surface 22 and transparent conductive thin film, coating or layer 50 (that is deposited on flexible substrate 40) so as to avoid false-touch sensing of the touch screen. Preferably, such spacer members/dots are as described in U.S. provisional patent application Ser. No. 60/234,867, filed Sep. 22,2000 entitled IMPROVED SPACER ELEMENTS FOR INTERACTIVE INFORMATION DEVICES, the disclosure of which is hereby incorporated by reference herein in its entirety. The transparent conductive film or coating 50 is typically indium tin oxide (although tin oxide or doped tin oxide may also be used), preferably deposited using a conventional coating deposition technique known as physical vapor deposition (preferably by web coating) on flexible transparent substrate 40. Flexible substrate 40 typically comprises a polyester film, such as PET. A suitable flexible film is Mylar® available from DuPont of Wilmington, Del.

Alternately, as shown in embodiment 60′ in FIG. 1A, transparent, insulating spacer members or dots 30a, which are substantially similar to spacer dots 30 described above, may be arranged and located on surface 51 or conductive thin film coating 50 in the same manner as described above for dots 30 on surface 22 also to avoid false-touch sensing of the touch screen.

In yet another embodiment 60″, shown in FIG. 1B, spacer members or dots 30b may be located and arranged on surface 22 of conductive coating 20 while spacer members 30c may be arranged and located on surface 51 of conductive thin film coating 50. Spacer members or dots 30b and 30c are substantially similar to spacer members or dots 30 described above. In embodiment 60″, however, spacer dots 30b, 30c alternate on opposite sides of the gap on coatings 20, 50 and are spaced at greater a distance from one another on each of the opposing surfaces so as not to be aligned with or engage one another but allow the conductive coatings 20, 50 to engage one another between the spacer dots when flexible film 40 is touched or pressed.

More specifically, plastic substrate 10 (that is typically a rigid substrate), as shown in FIGS. 1, 1A and 1B has improved physical and chemical properties in comparison to conventional plastics such as polycarbonate and acrylic for use in information display devices, and especially for interactive information display devices that are subject to mechanical interaction (and thus subject to potential scratching, indenting, wear and the like) between flexible transparent substrate 40 and the opposing outer surface 24 (that typically is overcoated with transparent conductive coating 20) of rigid substrate 10 when the interactive device is touched such as with a finger or a stylus. Improved characteristics of the substrate include low material density or specific gravity to obtain lightweight characteristics. The preferred specific gravity is below about 1.2, more preferably below about 1.1 and most preferably below about 1.05. Characteristics such as dimensional stability when exposed to heat and humidity are also important. The material properties of the polymer material used to form plastic substrate 10, such as of percentage water absorption, and thermal expansion, are also important factors. The preferred coefficient of thermal expansion, (CTE) for plastic substrate 10 is preferably close to the CTE of the material used for flexible transparent substrate 40. Flexible transparent substrate 40 typically comprises a flexible plastic sheet fabricated of a PET such as Mylar® or the like, having a CTE of about 1.2XE-5 per degree K. Preferably, the CTE of the material used to form plastic substrate 10 is less than about 6.5 XE-5 per degree K. Preferably, the material used to form plastic substrate 10 also has a low water absorption so as not to warp or swell going from a low to high humidity conditions and/or to be difficult to bond to. The preferred percentage water absorption by weight for plastic substrate 10 is preferably less than about 0.2% and more preferably less than about 0.1% and most preferably less than about 0.05%, by weight. A high heat distortion temperature for plastic substrate 10 is important to allow it retain shape even when heated during any coating process used to deposit transparent conductor layer 20 on surface 24 of substrate 10. The preferred heat distortion temperature is greater than about 120 degrees C.; more preferred greater than about 130 degrees C.; and most preferred greater than about 145 degrees C. Having a high stiffness for plastic substrate 10 is also important in many touch-interaction devices, and particularly given that the gap between transparent substrate 40 and plastic substrate 10 is typically smaller than 100 microns; and can be as small as 50 to 10 microns. Also, the higher the elastic modulus of the material used for plastic substrate 10, the thinner (and hence the lighter) plastic substrate 10 can be to achieve a given stiffness. In this regard, a flexural modulus of at least about 300 Kpsi is preferred; at least about 400 Kpsi more preferred; and at least about 500 Kpsi most preferred. Impact strength is also important, and particularly for interactive panels. Preferably, IZOD impact strength of the polymer material used for plastic substrate 10 is at least about 0.4 ft-lb/in. A high tensile strength for plastic substrate 10 is desirable, with at least about 8 Kpsi preferred; at least about 9 Kpsi more preferred. Abrasion resistance, and resistance to scratching or indenting even when not protected with an anti-abrasion overcoat, is an important property for plastic substrate 10. Also, low outgassing is important, as many of the coating techniques used to form transparent conductor layer 20 involve processing substrate 10 in a vacuum chamber. Excellent optical properties such as low haze, high visible light transmission and high clarity are also important for plastic substrate 10. Preferably, transmission of incident visible light (measured photopically) is at least about 90%, with at least about 92% more preferred. Clarity is preferably at least 98%; at least 99% more preferred. Haze is preferably less than about 1.5%; less than about 1% more preferred and less than about 0.8% most preferred. Preferably, the polymer material used for transparent plastic substrate 10 is a thermoplastic polymer that can be formed by melt-processing techniques such as extrusion and injection molding, and particularly by injection molding. To suit establishment of deletion lines during processing, the material used for plastic substrate 10 should be chemically resistant, and particularly, be resistant to acid etching [such as with hydrochloric acid (HCl)]. In this regard, COC materials, being olefinic, are chemically resistant to acids and bases, and to polar solvents such as methanol. These properties are also important for the manufacturability of plastic substrate 10 as well as relating to the ability for thin film deposition onto surface 24 of substrate 10 and the resulting mechanical, optical, and electrical stability of the thin film conductor as-deposited (and thus preferably eliminating the need for a hard coat as required by non-COC materials conventionally used for optical plastics). The preferred plastic material exhibiting the characteristics for use in information devices comprises a cyclic olefin copolymer (COC) such as Topas available from Ticona of Summit, N.J., USA. The ratio of cyclic olefin to non-cyclic olefin (or to other monomers present) can be adjusted to achieve the desired optical, chemical and mechanical properties for plastic substrate 10, as desired for a particular information display application. An example of a suitable cyclic olefin copolymer is ethylene-norbornene copolymer.

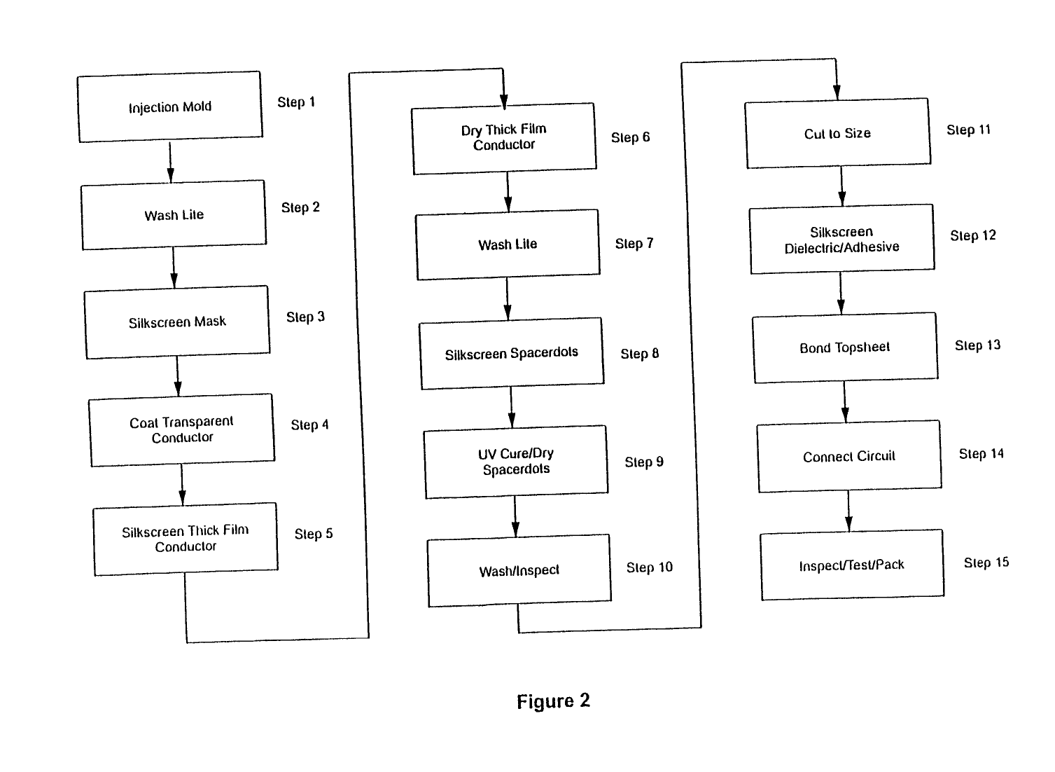

The preferred process, for example, for the manufacturing of an improved touch input device using an improved plastic substrate is shown in FIG. 2. Substrate 10 is preferably formed by molding COC resin (such as Topas 5013) in a conventional injection molding process to obtain the required substrate, bent or flat, product configuration. Further, it is most preferred that the substrate have an anti-glare surface such as imparted by a matte finish created during the injection molding process. Following the injection molding of the substrate, the substrate is washed using conventional glass washing techniques (that can include ultrasonic cleaning, brush washing and/or plasma cleaning). Prior to the deposition of the transparent conductor thin film, a pattern of a mask material may be applied to the surface of substrate 10 (which optionally is provided as a stock lite from which specific interactive display shapes can be later cut) using a silk screen coating method, such as one using a 325-mesh stainless steal screen. This allows later removal of the thin film conductor, indium tin oxide for example, following the deposition of the conductive film in order to establish deletion lines/regions such as by chemical means. The conductive thin film, preferably indium tin oxide, is then deposited on the lite, preferably by the sputtering physical vapor deposition technique or evaporation physical vapor deposition technique. During deposition, surface activation techniques such as heating, plasma activation, ion plating and/or ion bombardment can be used to activate surface 24 of substrate 10 in order to assist development of a highly transparent, highly conductive coating on surface 24 (specific resistivity less than about 2.5XE-4 ohm.cm preferred; less than about 2.OXE-4 ohm.cm more preferred and less than about 1.8XE-4 ohm.cm most preferred). A low temperature (less than about 250 degrees F. firing temperature conductive paste preferred; more preferably less than about 230 degrees F. firing temperature; less than about 210 degrees F. firing temperature most preferred) thick film conductive electrode pattern (typically a conductive silver epoxy resin) is then applied using a silk screen coating method, such as with a 325 stainless steel mesh silk screen with epoxy, as required based on the touch screen design. The thick film conductor is then cured using a low temperature firing process, preferably less than about 175 degrees C.; less than about 150 degrees C. more preferred and less than about 125 degrees C. most preferred. Short cure time is preferred, with less than about 60 minutes preferred; less than about 45 minutes more preferred and less than about 30 minutes most preferred. Following firing of the thick film, the lite is cleaned using conventional substrate cleaning techniques (such as conveyorized washing, ultrasonic cleaning, plasma cleaning, ozone cleaning and the like). This prepares the coated substrate for the application of the spacer dots and removes residual mask material for the deletion of specific areas of the thin film conductor as required by the touch screen design. The transparent conductor may also be deleted following curing using photolithography or laser deletion methods. The spacer members or dots, which are typically formed from a transparent polymeric material such as acrylic or polystyrene or the like, are then applied using conventional silk screening techniques using a 400-mesh stainless steel screen. The spacer dots can be cured using UV curing processes, typically at an energy level of 400 mJ/cm2. The lites are then washed my using conventional cleaning techniques such as are described above and then inspected. The lites are then cut to final touch screen dimensions using conventional cutting techniques (laser cutting or water-jet cutting preferred). Dielectric materials and adhesives, as known in the art, are applied to the resulting rigid plastic substrate shape. The flexible conductive top sheet is then bonded to the conductive rigid substrate with the spacer dots separating the top sheet from the rigid substrate preferably by an optical adhesive. A flexible electric connector is optionally electrically connected to the completed assembly for use in the information device. The device is then inspected and tested electronically. The resulting product is the complete interactive information device.

It is also possible that a substrate such as that shown at 10 may be formed from a cycle olefin and either uncoated or coated as shown in FIG. 1 with a transparent, electrically conductive coating such as tin oxide, indium tin oxide or doped tin oxide as a thin film such as that shown at 20, and may be used as a substrate in an information display such as a liquid crystal display, a plasma display, a field emission display, an electroluminescent display, an electrochromic display, or a cathode ray tube display. In this form of the invention, the substrate is formed substantially as described herein in accord with the other embodiments except that it may either be coated with a transparent electrically conductive thin film or be uncoated but, in either case, without incorporating a flexible transparent substrate thereon or aligned therewith. The same physical properties making the cyclic olefin polymeric substrate suitable for use in the interactive information devices described above and hereafter, also make the substrate suitable for use in information displays because the substrate is light weight, dimensionally stable, durable, and abrasion, break and flex resistant as well as being melt-processable, chemically resistant, resistant to acid etching and having low outgassing properties.

In some forms of the invention, it may be useful to incorporate a reduced glare, conductive coated panel having increased visible light transmission and suitable for use as a touch screen, digitizer panel or substrate in an information display and incorporating one or more thin film interference layers forming a thin film stack on opposite surfaces of a substrate such as that described herein and a transparent electrically conductive coating on the outer most layer of one or both of the thin film stacks, such as described in U.S. patent application Ser. No. 09/883,654, filed Jun. 18, 2001 entitled ENHANCED LIGHT TRANSMISSION CONDUCTIVE COATED TRANSPARENT SUBSTRATE AND METHOD FOR MAKING SAME, the disclosure of which is hereby incorporated by reference herein.

In some forms of the present invention, it may also be useful to incorporate a flexible, transparent, conductively coated layer with a rigid, transparent, conductively coated substrate such as that described herein to form an interactive information device and to include spacer members or dots as described in U.S. patent provisional patent application Ser. No. 60/234,867, filed Sep. 22, 2000 entitled IMPROVED SPACER ELEMENTS FOR INTERACTIVE INFORMATION DEVICES, the disclosure of which is incorporated by reference herein as set forth above. Such an assembly includes an improved process and materials for producing uniformly dispersed, consistent, durable, essentially non-visible, fixed substrate-interpane-spacer elements (for example “spacer dots”) for spacing opposing conductive surfaces of the flexible top sheet and rigid bottom sheet or substrate of such an interactive information device.

The present invention may also include the use of a reduced contrast, increased transmission, conductively coated panel wherein optical in-homogeneity is reduced between the transparent conductively coated regions and the non-coated regions rendering these delineation regions essentially visually indistinguishable when viewed so that there is no substantial contrast apparent when viewed in reflected light as described in U.S. provisional patent application Ser. No. 60/239,788, filed Oct. 12, 2000 entitled REDUCED CONTRAST IMPROVED TRANSMISSION CONDUCTIVELY COATED TRANSPARENT SUBSTRATE, the disclosure of which is hereby incorporated by reference in its entirety.

Also, cyclic olefin polymer resin can be used to form a rigid (preferably non-conductively coated) panel or backplate for use in a resistive membrane touch device where the cyclic olefin panel functions as a transparent backplate for a flexible, conductive, transparent, touch-membrane assembly. Use of a cyclic olefin backplate in such a configuration is preferred due to its abrasion resistance, being less subject to swelling or warp in high or low temperatures and/or high humidity conditions, out-gassing, high stiffness, good impact strength, low specific gravity, good thermal properties, melt processibility, and other consumer preferred product characteristics.

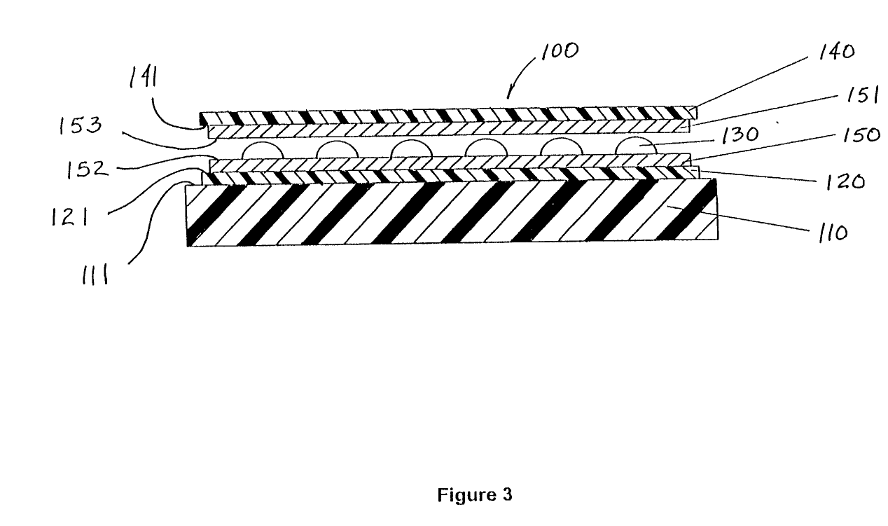

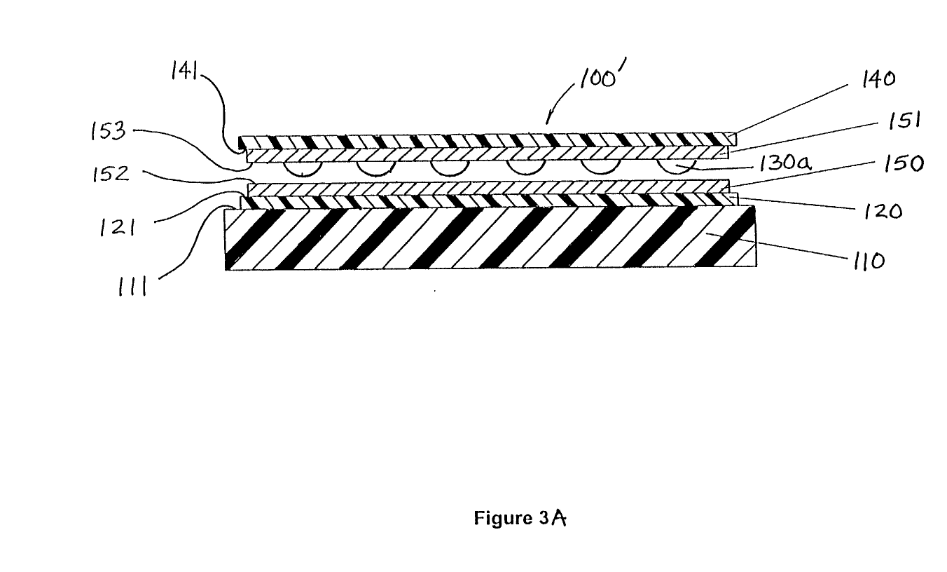

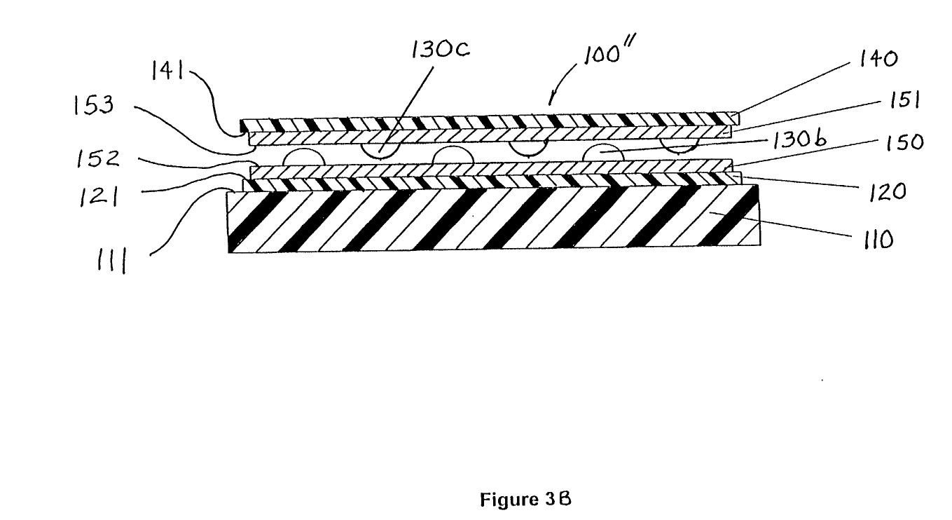

A preferred configuration 100 of the present invention when used as a backplate is shown in FIG. 3 and consists of a cyclic olefin backplate 110 with a transparent, conductively coated polymer film 120 (preferably a polyester film such as Mylar® available from DuPont of Wilmington, Del.) disposed on/affixed to and supported by surface 111 of cyclic olefin backplate 110. Typically, film 120 is affixed to surface 111 by a suitable optical adhesive. A second conductively coated flexible polymer (preferably Mylar®) film 140 is spaced from polymer film 120 by non-conductive, transparent insulating elements 130 (commonly known as spacer members or dots). Spacer dots 130 are formed, arranged and located in the same manner as described above for spacer dots 30. Conductive coatings 150 and 151 (typically indium tin oxide) are disposed on the opposing surfaces of polymer films 120 and 140, respectively. Spacer members or dots 130 provide separation between the conductive layers 150 and 151, and are disposed/affixed to surface 152 of conductive coating 150 (as shown in embodiment 100 of FIG. 3) preferably in the manner described above.

Alternately, as shown in embodiment 100′ of FIG. 3A, spacer dots 130a, which are substantially similar to spacer dots 130 described above, may be disposed/affixed to surface 153 of conductive coating 151.

As shown in embodiment 100″ of FIG. 3B, spacer dots 130b and 130c may be disposed on or affixed to both surfaces 152 and 153 in which case dots 130b and 130c are spaced apart on the opposing surfaces 152 and 153 so as not to be aligned with or engage one another but allow the conductive coatings 150 and 151 to engage one another when flexible film 140 is pressed. Thus, dots 130b are on surface 152, while dots 130c are on surface 153.

Backing plates 110, 110′ or 110″ each function as a backplate for the flexible touch-membrane formed by films 120 and 140 such that when film 140 is compressed (such as, for example, by a finger or stylus touch) toward film 120 such that layer 151 is shorted to layer 150 by contact, backplates 110, 110′, 110″ provide an optically transparent rigid backing plate. The resulting product is a complete interactive transparent touch device 100, 110′ or 110″.

While several forms of the invention have been shown and described, other forms will now be apparent to those skilled in the art. Therefore, it will be understood that the embodiments shown in the drawings and described above are merely for illustrated purposes, and are not intended to limit the scope of the invention which is to find by the claims which follow including the doctrine of equivalence.

The embodiment of the invention in which an exclusive property or privilege is claimed are as follows:

1. An interactive information device comprising:
at least one rigid, transparent substrate formed from a polymer material;
a first transparent, electrically conductive layer supported by a surface of said rigid substrate;
a flexible transparent substrate at least partially aligned with said rigid substrate, said flexible substrate having a surface which faces said surface of said rigid substrate, and a second transparent, electrically conductive layer on said surface of said flexible substrate; said flexible substrate being spaced from said rigid substrate to provide a gap between said conductive layers;
a plurality of insulating spacer members on at least one of said electrically conductive layers whereby said flexible substrate may be flexed by pressing to engage said electrically conductive layers between said spacer members; and
wherein said rigid substrate comprises a cyclic olefin copolymer.

2. The interactive information device of claim 1 wherein said first conductive layer comprises a conductive coating deposited on said surface of said rigid substrate.

3. The interactive information device of claim 2 wherein said conductive coating is selected from the group consisting of tin oxide, indium tin oxide and doped tin oxide.

4. The interactive information device of claim 3 wherein said conductive coating has a sheet resistance in the range of between about 80 and 1200 ohms/square.

5. The interactive information device of claim 4 wherein said conductive coating has a specific resistivity of less than about 2.5XE-4 ohm.cm.

6. The interactive information device of claim 2 wherein said second conductive layer comprises a conductive coating deposited on said flexible substrate surface.

7. The interactive information device of claim 6 wherein said flexible substrate is formed from a polymeric film.

8. The interactive information device of claim 7 wherein said second conductive coating is selected from the group consisting of tin oxide, indium tin oxide and doped tin oxide.

9. The interactive information device of claim 8 wherein said conductive coating has a sheet resistance in the range of between about 80 and 1200 ohms/square.

10. The interactive information device of claim 9 wherein said conductive coating has a specific resistivity of less than about 2.5XE-4 ohm.cm.

11. The interactive information device of claim 1 including another, flexible, transparent substrate at least partially aligned with said rigid substrate, said first transparent, electrically conductive layer including a conductive coating on a surface of said another flexible transparent substrate, said surface of said another flexible transparent substrate facing said second transparent conductive layer, said rigid substrate forming a supporting backplate for said another flexible substrate.

12. The interactive information device of claim 11 wherein said another flexible substrate is formed from a polymeric film.

13. The interactive information device of claim 12 wherein said second conductive layer comprises a conductive coating, said conductive coating being selected from the group consisting of tin oxide, indium tin oxide and doped tin oxide.

14. The interactive information device of claim 13 wherein each of said conductive coatings has a sheet resistance in the range of between about 80 and 1200 ohms/square.

15. The interactive information of claim 14 wherein each of said conductive coatings has a specific resistivity of less than about 2.5XE-4 ohm.cm.

16. The interactive information device of claim 1 wherein said cyclic olefin copolymer of said rigid substrate has a specific gravity below about 1.2.

17. The interactive information device of claim 16 wherein said cyclic olefin copolymer of said rigid substrate has a coefficient of thermal expansion is less than about 6.5XE-5 per degree K.

18. The interactive information device of claim 17 wherein said cyclic olefin copolymer of said rigid substrate has a percentage of water absorption by weight of less than about 0.2%.

19. The interactive information device of claim 18 wherein said cyclic olefin copolymer of said rigid substrate has a heat distortion temperature of greater than about 120 degrees C.

20. The interactive information device of claim 19 wherein said cyclic olefin copolymer of said rigid substrate has a flexular modulus of at least about 300 Kpsi.

21. The interactive information device of claim 20 wherein said cyclic olefin copolymer of said rigid substrate has an IZOD impact strength of at least about 0.4 ft-lb/in.

22. The interactive information device of claim 21 wherein said cyclic olefin copolymer of said rigid substrate has a tensile strength of at least about 8 Kpsi.

23. The interactive information device of claim 22 wherein said cyclic olefin copolymer of said rigid substrate has a visible light transmission measured photopically of at least about 90%.

24. The interactive information device of claim 23 wherein said cyclic olefin copolymer of said rigid substrate has a clarity of at least about 98%.

25. The interactive information device of claim 24 wherein said cyclic olefin copolymer of said rigid substrate has haze of less than about 1.5%.

26. The interactive information device of claim 25 wherein said cyclic olefin copolymer of said rigid substrate is at least one of melt processable, chemically resistant, resistant to acid etching and has low out-gassing properties.

27. The interactive information device of claim 1 wherein said cyclic olefin copolymer of said rigid substrate has a coefficient of thermal expansion is less than about 6.5XE-5 per degree K.

28. The interactive information device of claim 1 wherein said cyclic olefin copolymer of said rigid substrate has a percentage of water absorption by weight of less than about 0.2%.

29. The interactive information device of claim 1 wherein said cyclic olefin copolymer of said rigid substrate has a heat distortion temperature of greater than about 120 degrees C.

30. The interactive information device of claim 1 wherein said cyclic olefin copolymer of said rigid substrate has a flexular modulus of at least about 300 Kpsi.

31. The interactive information device of claim 1 wherein said cyclic olefin copolymer of said rigid substrate has an IZOD impact strength of at least about 0.4 ft-lb/in.

32. The interactive information device of claim 1 wherein said cyclic olefin copolymer of said rigid substrate has a tensile strength of at least about 8 Kpsi.

33. The interactive information device of claim 1 wherein said cyclic olefin copolymer of said rigid substrate has a visible light transmission measured photopically of at least about 90%.

34. The interactive information device of claim 1 wherein said cyclic olefin copolymer of said rigid substrate has a clarity of at least about 98%.

35. The interactive information device of claim 1 wherein said cyclic olefin copolymer of said rigid substrate has haze of less than about 1.5%.

36. The interactive information device of claim 1 wherein said cyclic olefin copolymer of said rigid substrate is at least one of melt processable, chemically resistant, resistant to acid etching and has low out-gassing properties.

37. The interactive information device of claim 1 wherein said insulating spacer members are transparent, are spaced from on another, and are located on said first transparent, electrically conductive layer.

38. The interactive information device of claim 1 wherein said insulating spacer members are transparent, are spaced from one another, and are located on said second transparent, electrically conductive layer.

39. The interactive information device of claim 1 wherein said insulating spacer members are transparent, are spaced from one another, and are located on both said first and second transparent, electrically conductive layers, said spacer members being spaced apart on said first and second conductive layers such that said spacer members allow said conductive layers to engage one another wherein said flexible transparent substrate is pressed.

40. An interactive information device comprising:
at least one rigid, transparent, conductively coated, plastic substrate having a transparent, electrically conductive coating on a surface thereof;
a flexible transparent substrate at least partially aligned with said surface of said rigid substrate and having a transparent, electrically conductive coating on a surface which faces said surface of said rigid substrate, said flexible substrate being spaced from said rigid substrate to provide a gap between said conductive coatings on said respective substrates;
a plurality of insulating spacer members on said electrically conductive coating on at least one of said substrates whereby said flexible substrate may be flexed by pressing to engage said electrically conductive coatings between spacer members; and
wherein said plastic substrate comprises a cyclic olefin copolymer.

41. The information device of claim 40 wherein said cyclic olefin copolymer comprises an ethylene-norbornene copolymer.

42. A method for making an interactive information device comprising:
providing a rigid, transparent substrate formed from a polymeric material comprising a cyclic olefin copolymer;
providing a first transparent, electrically conductive layer supported by a surface of said rigid substrate;
providing a first flexible, transparent substrate having a second transparent electrically conductive layer on a surface thereof;
providing plurality of insulating spacer members on at least one of said first and second electrically conductive layers; and
securing said first flexible substrate to said rigid substrate such that said first and second electrically conductive layers on said respective substrates are at least partially aligned with one another and spaced from one another by a gap in which said spacer members are positioned whereby said flexible substrate may be flexed by pressing to engage said conductive layers.

43. The method of claim 42 including supporting said first, electrically conductive layer by coating a surface of said rigid substrate with said first transparent, electrically conductive layer.

44. The method of claim 43 including coating said rigid substrate surface by vapor deposition.

45. The method of claim 44 including activating the surface of said rigid substrate during said vapor deposition by at least one of heating, plasma activation, ion plating, and/or ion bombardment.

46. The method of claim 43 including deleting portions of at least one of said first and second electrically conductive layers to provide a touch screen pattern.

47. The method of claim 46 including deleting said portions of said one electrically conductive layer by a method selected from the following group consisting of conveyorized cleaning, ultrasonic cleaning, plasma cleaning, ozone cleaning, photolithography and laser deletion.

48. The method of claim 42 including supporting said first electrically conductive layer by providing a second flexible, transparent substrate having said first electrically conductive layer thereon, and securing said second flexible substrate to said surface of said rigid substrate.

49. The method of claim 42 including forming said spacer members by silk screening a transparent, polymeric material on at least said one electrically conductive layer, and curing said formed spacer members after silk screening.

50. The method of claim 49 including forming said spacer members by silk screening said transparent, polymeric material on both of said first and second electrically conductive layers, and curing said formed spacer members.

51. In an information display selected from the group consisting of a liquid crystal display, a plasma display, a field emission display, an electroluminescent display, an electrochromic display and a cathode ray tube display, the improvement comprising:
a rigid substrate formed from cyclic olefin copolymer polymeric material.

52. The information display of claim 51 wherein said substrate is at least one of lightweight, dimensionally stable, durable, break resistant, and flex resistant.

53. The information display of claim 51 including a transparent electrically conductive layer on a surface thereof.

54. The information display of claim 51 wherein said cyclic olefin copolymer of said rigid substrate has a specific gravity below about 1.2.

55. The information display of claim 54 wherein said cyclic olefin copolymer of said rigid substrate has a coefficient of thermal expansion is less than about 6.5XE-5 per degree K.

56. The information display of claim 55 wherein said cyclic olefin copolymer of said rigid substrate has a percentage of water absorption by weight of less than about 0.2%.

57. The information display of claim 56 wherein said cyclic olefin copolymer of said rigid substrate has a heat distortion temperature of greater than about 120 degrees C.

58. The information display of claim 57 wherein said cyclic olefin copolymer of said rigid substrate has a flexular modulus of at least about 300 Kpsi.

59. The information display of claim 58 wherein said cyclic olefin copolymer of said rigid substrate has an IZOD impact strength of at least about 0.4 ft-lb/in.

60. The information display of claim 59 wherein said cyclic olefin copolymer of said rigid substrate has a tensile strength of at least about 8 Kpsi.

61. The information display of claim 60 wherein said cyclic olefin copolymer of said rigid substrate has a visible light transmission measured photopically of at least about 90%.

62. The information display of claim 61 wherein said cyclic olefin copolymer of said rigid substrate has a clarity of at least about 98%.

63. The information display of claim 62 wherein said cyclic olefin copolymer of said rigid substrate has haze of less than about 1.5%.

64. The information display of claim 63 wherein said cyclic olefin copolymer of said rigid substrate is at least one of melt processable, chemically resistant, resistant to acid etching and has low out-gassing properties.

65. The information display of claim 51 wherein said cyclic olefin copolymer of said rigid substrate has a coefficient of thermal expansion is less than about 6.5XE-5 per degree K.

66. The information display of claim 51 wherein said cyclic olefin copolymer of said rigid substrate has a percentage of water absorption by weight of less than about 0.2%.

67. The information display of claim 51 wherein said cyclic olefin copolymer of said rigid substrate has a heat distortion temperature of greater than about 120 degrees C.

68. The information display of claim 51 wherein said cyclic olefin copolymer of said rigid substrate has a flexular modulus of at least about 300 Kpsi.

69. The information display of claim 51 wherein said cyclic olefin copolymer of said rigid substrate has an IZOD impact strength of at least about 0.4 ft-lb/in.

70. The information display of claim 51 wherein said cyclic olefin copolymer of said rigid substrate has a tensile strength of at least about 8 Kpsi.

71. The information display of claim 51 wherein said cyclic olefin copolymer of said rigid substrate has a visible light transmission measured photopically of at least about 90%.

72. The information display of claim 51 wherein said cyclic olefin copolymer of said rigid substrate has a clarity of at least about 98%.

73. The information display of claim 51 wherein said cyclic olefin copolymer of said rigid substrate has haze of less than about 1.5%.

74. The information display of claim 51 wherein said cyclic olefin copolymer of said rigid substrate is at least one of melt processable, chemically resistant, resistant to acid etching and has low out-gassing properties.
